(19) United States
(12) Patent Application Publication
(10) Pub. No.: US 2026/0126711 A1
(43) Pub. Date: May 7, 2026

(54) ELECTRONIC DEVICE HOLDER

(71) Applicant: TILTA INC., Burbank, CA (US)

(72) Inventors: Shengzhao LIU, Shenzhen (CN); Hong ZHANG, Shenzhen (CN); Wenping ZENG, Shenzhen (CN); Kefeng ZHOU, Shenzhen (CN)

(21) Appl. No.: 19/374,836

(22) Filed: Oct. 30, 2025

(30) Foreign Application Priority Data
Nov. 4, 2024 (CN) 202422685500.5
Nov. 4, 2024 (CN) 202422685710.4

(51) Int. Cl. G03B 17/56; F16M 13/02

(52) U.S. Cl. CPC G03B 17/566; F16M 13/02; G03B 17/561

(57) ABSTRACT

An electronic device holder includes a mounting assembly and a support assembly. The mounting assembly includes a first connection part and a mounting part for securing an electronic device, with the first connection part positioned inside the mounting part. The support assembly is connected to the mounting part and is equipped with a camera connection part for attaching to a camera. During use of the electronic device holder, the user can mount an electronic device using the mounting part and connect it to a camera via the camera connection part. This arrangement allows the device to be mounted and supported on the camera, enabling coordinated shooting between the camera and the electronic device.

### CROSS-REFERENCE TO RELATED APPLICATIONS

The present application for patent claims priority to and the benefit of pending Chinese Application No. 2024226857104, filed Nov. 4, 2024 and No. 2024226855005, filed Nov. 4, 2024, which are expressly incorporated by reference herein as if fully set forth below in its entirety and for all applicable purposes.

### TECHNICAL FIELD

The present disclosure pertains to the technical field of electronic device accessories, specifically to an electronic device holder.

### INTRODUCTION

In contemporary daily life, electronic devices such as mobile phones and tablets have become indispensable tools. People frequently utilize these devices for activities like watching videos and working. The widespread presence of electronic devices has given rise to the extensive use of electronic device accessories, such as electronic device holders.

Taking a mobile phone as an example of an electronic device, existing mobile phone holders typically include a phone connection component, such as a phone clip or a magnetic ring, which is then attached to an adjustable base. This setup is designed to fix the mobile phone and enable angle adjustments. However, in an increasing number of scenarios, mobile phones are now being used to assist or collaborate with cameras during shooting. Current mobile phone holders are struggling to meet this emerging demand.

### BRIEF SUMMARY

Aspects of the present disclosure provide an electronic device holder that supports electronic or mobile devices, such as mobile phones or tablets, for assisting a camera during shooting, thereby meeting user shooting requirements.

Some aspects of the present disclosure provide: an electronic device holder, including: a mounting assembly, which includes a first connection part and a mounting part for securing an electronic device. The first connection part is located inside the mounting part. The electronic device holder further includes a support assembly, which is connected to the mounting part and is provided with a camera connection part for attaching to a camera.

During use of the electronic device holder, the user can mount an electronic device (e.g., a mobile phone or tablet) using the mounting part and connect the electronic device to a camera via the camera connection part. This enables the electronic device to be mounted and supported on the camera, fulfilling the user's need for coordinated shooting between the camera and the electronic device (e.g., a mobile phone or tablet).

### BRIEF DESCRIPTION OF THE DRAWINGS

To elucidate the various aspects of the present disclosure, the accompanying drawings for describing exemplary embodiments will be briefly introduced below. It is apparent that the accompanying drawings described herein represent merely some embodiments of the present disclosure. For those skilled in the art, without the necessity for inventive effort, other examples can be derived based on the exemplary embodiments depicted in these drawings.

FIG. 1 is a schematic diagram illustrating an electronic device holder according to some aspects of the disclosure.

FIG. 2 is an exploded view illustrating the electronic device holder according to some aspects of the disclosure.

FIG. 3 is a schematic diagram illustrating the electronic device holder according to some aspects of the disclosure.

FIG. 4 is a schematic diagram illustrating the electronic device holder according to some aspects of the disclosure.

### REFERENCE NUMERALS

10. Electronic device holder;

1. Mounting assembly; 11. mounting part (Magnetic ring); 111. First side; 1111. First magnetic attachment part; 112. Second side; 1121. Second magnetic attachment part; 12. First connection part; 121. First interface; 1211. First rotational coupling interface; 1212. First disassembly notch; 122. Positioning hole; 123. Connection ring; 124. Support arm;

2. Support assembly; 21. Second interface; 211. Second rotational coupling interface; 212. Second disassembly notch; 213. Operational part; 2131. Receiving groove; 22. Elastic member; 23. Second connection part; 24. Base unit; 241. Support arm; 2411. First arm segment; 24111. Hinge part; 2412. Second arm segment; 2413. Third arm segment; 2414. Third rotational coupling interface; 2415. Third disassembly notch; 242. Base; 2421. Fourth rotational coupling interface; 2422. Fourth disassembly notch; 243. Camera connection part.

The objectives, functional characteristics, and advantages of the disclosure will be further elucidated with reference to the embodiments and accompanying drawings.

### DETAILED DESCRIPTION

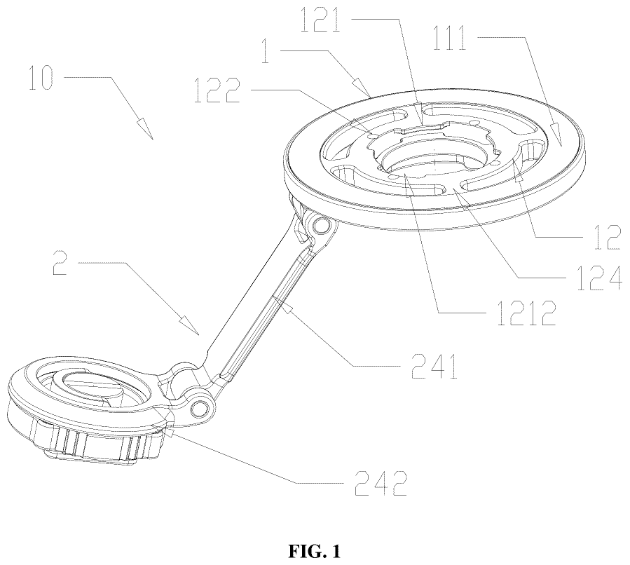

Referring to FIG. 1 - 4, an electronic device holder 10 includes a mounting assembly 1 and a support assembly 2. The mounting assembly 1 includes a first connection part 12 and a mounting part 11 for securing an electronic device. The first connection part 12 is situated inside the mounting part 11. The support assembly 2 is connected to the mounting part 11 and can be equipped with a camera connection part for attaching to a camera.

In some aspects, the mounting part can take the form of a phone clip or utilize a magnetic connection method. In one example, the mounting part can include a magnetic ring 11, which includes a first magnetic attachment part 1111 and a second magnetic attachment part 1121. The camera connection part can be one of the following: a cold shoe mount, a cold shoe slot, a standardized camera mounting interface (e.g., a NATO rail, a Manfrotto plate, an Arca-Swiss plate), ¼ threaded interface, or ⅜ threaded interface. Using the electronic device holder, a user can mount an electronic device (e.g., a mobile phone or tablet) using the mounting part and connect the electronic device to a camera via the camera connection part. This design allows the electronic device to be mounted and supported on the camera, enabling coordinated shooting between the camera and the electronic device.

The first connection part 12 has a first interface 121, and the support assembly 2 has a second interface 21. The first interface 121 and the second interface 21 can be detachably connected together to enable the detachable connection between the mounting assembly 1 and the support assembly 2. That is the mounting assembly 1 and the support assembly 2 can be removably connected.

The mounting assembly 1 enables easy disassembly and replacement with the electronic device holder 10. When different support assemblies 2 are to be used, the mounting assembly 1 and the support assembly 2 can be disassembled and separated by disconnecting the first interface 121 and the second interface 21. Then, another desired support assembly 2 can be attached to the mounting assembly 1. This offers flexibility in using the mounting assembly 1, enabling users to customize their desired usage modes. For example, it can be paired with a base 242 (a first version) having a camera connection part to connect to a camera, or with a base 242 (a second version) having an adhesive part to stick to a specific location. It can also be paired with a magnetic base 242 to magnetically attach to a structure or with a finger ring to allow the user to hold the mobile phone via the finger ring. Users can easily interchange different support assemblies 2 at any time by utilizing the detachable connection of the first interface 121 and the second interface 21, thereby achieving multi-purpose pairing with a single device.

In some aspects, the mounting assembly 1 includes a magnetic ring 11 and a first connection part 12. The first connection part 12 is connected to the magnetic ring 11 and has a first interface 121. The first interface 121 includes multiple first rotational coupling interfaces 1211. The second interface 21 includes multiple second rotational coupling interfaces 211. A first disassembly notch 1212 is between adjacent first rotational coupling interfaces 1211, and a second disassembly notch 212 is between adjacent second rotational coupling interfaces 211. The second rotational coupling interfaces 211 can be aligned with the first disassembly notches 1212, and the second rotational coupling interfaces 211 can be rotated relative to the first rotational coupling interfaces 1211. This allows the second rotational coupling interfaces 211 to engage with the first rotational coupling interfaces 1211 or be detached from the second disassembly notches 212. In some aspects, when the user needs to disassemble, rotating the support assembly 2 relative to the mounting assembly 1 causes the second rotational coupling interfaces 211 to rotate relative to the first rotational coupling interfaces 1211. When the second rotational coupling interfaces 211 align with the first disassembly notches 1212 and the first rotational coupling interfaces 1211 align with the second disassembly notches 212, the mounting assembly 1 and the support assembly 2 can be separated. When installing a support assembly 2, the second rotational coupling interfaces 211 can be aligned with the first disassembly notches 1212 and the first rotational coupling interfaces 1211 can be aligned with the second disassembly notches 212. Further rotating the second rotational coupling interfaces 211 causes them to rotate into engagement with the first rotational coupling interfaces 1211, completing the connection between the mounting assembly 1 and the support assembly 2.

In some aspects, one of the facing sides of the mounting assembly 1 and the support assembly 2 has an elastic member 22, and the other side has a positioning hole 122 (e.g., opening). When the first rotational coupling interfaces 1211 and the second rotational coupling interfaces 211 are engaged, the elastic member 22 is positioned in the positioning hole 122. For example, the support assembly 2 can be elastically equipped with a spring-loaded ball, and the connection component is provided with the positioning hole 122. With this configuration, during installation, the second rotational coupling interfaces 211 are aligned with the first disassembly notches 1212, and the support assembly 2 is pressed. Then, the support assembly 2 is rotated, causing the second rotational coupling interfaces 211 to rotate into engagement with the first rotational coupling interfaces 1211. At this time, the elastic member 22 is retained in the positioning hole 122 for positioning. On the other hand, under the elastic restoring force of the elastic member 22, the second rotational coupling interfaces 211 can press against the first rotational coupling interfaces 1211 to increase the stability of the engagement. During disassembly, rotating the support assembly 2 causes the elastic member 22 to slide out of the positioning hole 122. When the second rotational coupling interfaces 211 rotate to align with the first disassembly notches 1212, the mounting assembly 1 and the support assembly 2 can be detached. In some aspects, the elastic member 22 can be a spring-loaded ball. The specific structure of the spring-loaded ball can adopt any suitable existing configuration and will not be elaborated in detail here.

In some aspects, the magnetic ring 11 includes a first side 111 and a second side 112. The first side 111 has a first magnetic attachment part 1111, and the second side 112 has a second magnetic attachment part 1121. The first interface 121 includes two interfaces, which are oppositely disposed and correspond one-to-one with the first magnetic attachment part 1111 and the second magnetic attachment part 1121, respectively. In this example, the magnetic ring 11 and the support assembly 2 can be detached. The magnetic ring 11 can magnetically attract on both sides. Therefore, during use, the user can remove the magnetic ring 11 and reinstall it in a reversed orientation. This configuration enhances the functional versatility of the electronic device holder 10 described herein. For example, if the magnetism of the first magnetic attachment part 1111 weakens, the second magnetic attachment part 1121 can be used instead for magnetic attraction. Alternatively, depending on the magnetic polarity of the magnetic attraction object, the user can switch between using the first magnetic attachment part 1111 or the second magnetic attachment part 1121 for magnetic engagement or attraction.

In some aspects, the first connection part 12 includes a connection ring 123 and multiple support arms 124. The support arms 124 are connected between the magnetic ring 11 and the connection ring 123. The two first interfaces 121 are disposed on the inner wall of the connection ring 123 and are arranged opposite to each other. When the first interface 121 and the second interface 21 are connected, the second interface 21 can be accommodated between the two first interfaces 121. Correspondingly, there are two first interfaces 121 provided. Each first interface 121 includes a plurality of first rotational coupling interfaces 1211. As shown in the figures, the inner wall of the connection ring 123 has two sets of first rotational coupling interfaces 1211 to cooperate with the forward or reverse connection of the magnetic ring 11. During use, the user can align the second rotational coupling interfaces 211 with the first rotational coupling interfaces 1211 and rotate them, causing the first rotational coupling interfaces 1211 and the second rotational coupling interfaces 211 to engage with each other.

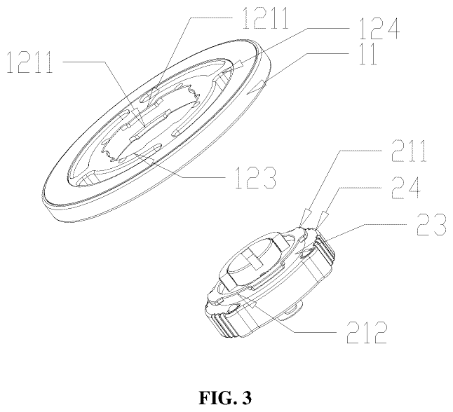

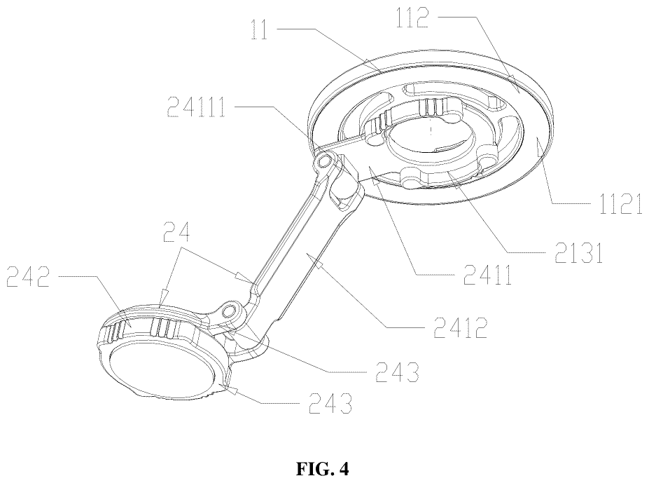

Referring to FIG. 3, the support assembly 2 can include a second connection part 23 and a base unit 24. The second connection part 23 is connected to the base unit 24 and has the second interface 21. In some aspects, as shown in the figure, after the base unit 24 is connected to the magnetic ring 11 via the second rotational coupling interfaces 211 on the second connection part 23, it can support the magnetic ring 11 and be placed on or connected to a surface. For example, it can be connected or placed on a surface via the camera connection part 243. For example, the camera connection part 243 can be an adhesive member, as shown in FIG. 4, facilitating the user to stick it onto a surface. Alternatively, the camera connection part 243 can be a magnetic structure, and the connection method of the magnetic structure can refer to the aforementioned connection method of the magnetic ring 11, thereby magnetically attaching to a surface or other electronic devices. In some aspects, the camera connection part 243 can be a camera connector, for example including one of a cold shoe mount, a cold shoe slot, a standardized interface (e.g., a NATO rail, a Manfrotto plate, an Arca-Swiss plate), ¼ threaded interface, and ⅜ threaded interface, for directly or indirectly connecting to a camera. For example, it can be directly connected to the hot shoe interface of a camera via a cold shoe mount, or a ¼ screw can pass through a ¼ threaded interface on a camera cage or the base unit 24 to lock the camera cage and the base unit 24, thereby indirectly connecting the base unit 24 to the camera. In some aspects, as mentioned above, the magnetic ring 11 herein can be used with base units 24 having different camera connection parts 243. The electronic device holder 10 herein has diverse usage modes, capable of meeting various user needs.

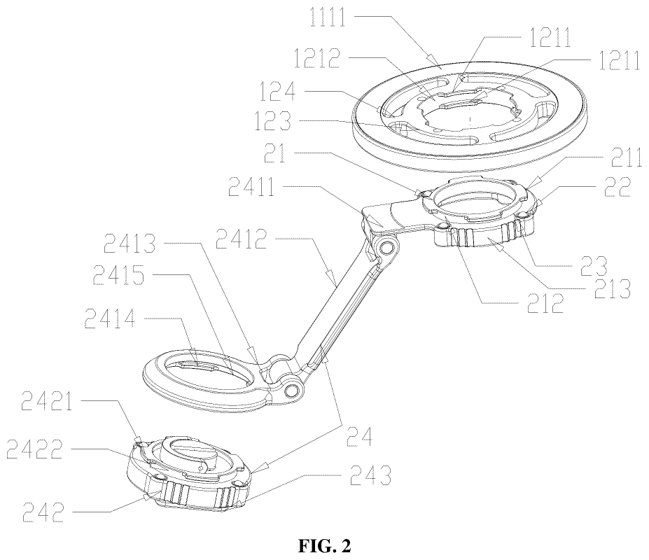

Referring to FIGS. 1, 2, and 4, in some aspects, the base unit 24 includes a support arm 241 and a base 242. The support arm 241 is detachably connected to the base 242. The end of the support arm 241 away from the base 242 is connected to the second connection part 23. For example, the base 242 can be connected to the aforementioned camera connection part 243. The support arm 241 includes a first arm segment 2411, a second arm segment 2412, and a third arm segment 2413, which are sequentially and rotatably connected. The second connection part 23 is disposed on the first arm segment 2411. The third arm segment 2413 is detachably connected to the base unit 24. This configuration allows the magnetic ring 11 to flexibly adjust its position and orientation relative to the base 242, facilitating user operation. In some implementations, the first arm segment 2411 further includes an operational part 213. The operational part 213 protrudes in a direction away from the second connection part 23, facilitating the user to act on the operational part 213 for disassembling or assembling the first connection part 12 and the second connection part 23. The operational part 213 has a receiving groove 2131. When folded, the second arm segment 2412 can be received within the receiving groove 2131. In some aspects, one side of the first arm segment 2411 is provided with a hinge part 24111. The end of the second arm segment 2412 away from the first arm segment 2411 is connected to the hinge part 24111, enabling at least a portion of the structure of the second arm segment 2412 to fit against the first arm segment 2411.

The third arm segment 2413 includes multiple third rotational coupling interfaces 2414. The base 242 includes multiple fourth rotational coupling interfaces 2421. A third disassembly notch 2415 is provided between adjacent third rotational coupling interfaces 2414. A fourth disassembly notch 2422 is provided between adjacent fourth rotational coupling interfaces 2421. The fourth rotational coupling interfaces 2421 can be aligned with the third disassembly notches 2415, allowing the fourth rotational coupling interfaces 2421 to be rotated to engage with the third rotational coupling interfaces 2414 or allowing the fourth rotational coupling interfaces 2421 to be detached from the third disassembly notches 2415. With this configuration, at this end of the third arm segment 2413, different camera connection parts 243 can also be flexibly matched to meet various user needs, allowing users to utilize the electronic device holder 10 herein in multiple combination ways.

Although specific embodiments of the invention have been described in detail, it should be understood that the invention is not limited to the exemplary configurations and components shown and described. Parts may be substituted, elements may be reversed, and certain features may be used independently of others, all without departing from the scope of the invention as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. An electronic device holder, comprising:
a mounting assembly comprising a first connection part and a mounting part for mounting an electronic device, wherein the first connection part is provided inside the mounting part; and
a support assembly configured to connect to the mounting part, and provided with a camera connection part configured to mount the electronic device holder to a camera.

2. The electronic device holder according to claim 1, wherein the support assembly comprises a support arm and a base;
wherein a first end of the support arm is connected to the first connection part and a second end of the support arm is connected to the base; and
wherein the base is provided with the camera connection part.

3. The electronic device holder according to claim 1, wherein the camera connection part comprises one of a cold shoe mount, a cold shoe slot, a NATO rail, a Manfrotto plate, an Arca-Swiss plate, a ¼ inch threaded interface, or a ⅜ inch threaded interface.

4. The electronic device holder according to claim 2, wherein the support arm comprises a first arm segment, a second arm segment, and a third arm segment;
wherein a first end of the first arm segment is connected to the first connection part and a second end of the first arm segment is rotatably connected to the second arm segment;
wherein a first end of the second arm segment distal to the first arm segment is rotatably connected to the third arm segment; and
wherein a first end of the third arm segment distal to the second arm segment is connected to the base.

5. The electronic device holder according to claim 4, wherein one side of the first arm segment is provided with a hinge part; and
wherein a second end of the second arm segment distal to the first arm segment is configured to connect to the hinge part, enabling at least a portion of the second arm segment to fit against the first arm segment.

6. The electronic device holder according to claim 4, wherein the mounting part comprises a magnetic ring; and
wherein the first connection part is disposed inside the magnetic ring and is connected to an inner wall of the magnetic ring.

7. The electronic device holder according to claim 6, wherein the first connection part comprises a connection ring and a plurality of support arms;
wherein the connection ring is located at a central portion of the magnetic ring; and
wherein one end of each of the plurality of support arms is connected to the inner wall of the magnetic ring and the other end is connected to an outer wall of the connection ring.

8. The electronic device holder according to claim 6, wherein the support arm and the first connection part are detachably connected via the magnetic ring.

9. The electronic device holder according to claim 8, wherein the first arm segment comprises a second connection part and an operational part;
wherein the operational part protrudes away from a side where the second connection part is located;
wherein the second connection part is detachably connected to the first connection part;
wherein the operational part is configured with a receiving groove; and
wherein the second arm segment is configured to be received within the receiving groove.

10. The electronic device holder according to claim 7, wherein the mounting assembly is provided with a first interface;
wherein the support assembly is provided with a second interface; and
wherein the first interface and the second interface is configured to be detachably connected.

11. The electronic device holder according to claim 10, wherein the first interface comprises a plurality of first rotational coupling interfaces;
wherein the second interface comprises a plurality of second rotational coupling interfaces;
wherein a first disassembly notch is formed between adjacent first rotational coupling interfaces among the plurality of first rotational coupling interfaces;
wherein a second disassembly notch is formed between adjacent second rotational coupling interfaces among the plurality of second rotational coupling interfaces; and
wherein the second rotational coupling interfaces are configured to align with the first disassembly notches, to enable the second rotational coupling interfaces to rotate relative to the first rotational coupling interfaces, thereby enabling the second rotational coupling interfaces to engage with the first rotational coupling interfaces or enabling the second rotational coupling interfaces to be detached from the second disassembly notches.

12. The electronic device holder according to claim 11, wherein the third arm segment comprises a plurality of third rotational coupling interfaces;
wherein the base comprises a plurality of fourth rotational coupling interfaces;
wherein a third disassembly notch is provided between adjacent third rotational coupling interfaces among the plurality of third rotational coupling interfaces;
wherein a fourth disassembly notch is provided between adjacent fourth rotational coupling interfaces among the plurality of fourth rotational coupling interfaces; and
wherein the fourth rotational coupling interfaces are configured to align with the third disassembly notches, thereby enabling the fourth rotational coupling interfaces to rotate into engagement with the third rotational coupling interfaces or enabling the fourth rotational coupling interfaces to be detached from the third disassembly notches.

13. The electronic device holder according to claim 11, wherein one of opposing sides of the mounting assembly and the support assembly is provided with an elastic member, and the other one is provided with a positioning hole; and
wherein in response to the first rotational coupling interfaces and the second rotational coupling interfaces being engaged, the elastic member is positioned in the positioning hole.

14. The electronic device holder according to claim 10, wherein the magnetic ring comprises a first side and a second side;
wherein the first side is configured with a first magnetic attachment part;
wherein the second side is configured with a second magnetic attachment part;
wherein the first interface comprises two first interfaces; and
wherein the two first interfaces are disposed opposite to each other and one interface correspond to the first magnetic attachment part and another interface correspond to the second magnetic attachment part in one-to-one manner.

15. The electronic device holder according to claim 14, wherein the first magnetic attachment part and the second magnetic attachment part are configured to be identical magnetic polarities or opposite magnetic polarities.

16. The electronic device holder according to claim 14, wherein the two first interfaces are disposed on an inner wall of the connection ring and are arranged opposite to each other; and
wherein in response to the first interface and the second interface being connected, the second interface is configured to be being accommodated between the two first interfaces.

17. The electronic device holder according to claim 1, wherein the camera connection part comprises an adhesive member or a magnetic structure.
